(19) United States
(12) Patent Application Publication
(10) Pub. No.: US 2025/0291022 A1
(43) Pub. Date: Sep. 18, 2025

(54) PREVENTING ALTIMETER INTERFERENCE

(71) Applicant: QUALCOMM INCORPORATED, San Diego, CA (US)

(72) Inventor: Tejinder Dip SINGH, Bangalore (IN)

(21) Appl. No.: 18/861,348

(22) PCT Filed: Jun. 8, 2023
(86) PCT No.: PCT/US2023/024851

§ 371 Date: Oct. 29, 2024

(30) Foreign Application Priority Data
Jun. 29, 2022 (IN) 202241037312

(51) Int. Cl. G01S 5/02; H04W 64/00

(52) U.S. Cl. CPC G01S 5/0294; H04W 64/006

(57) ABSTRACT

Various aspects of the present disclosure generally relate to wireless communication. In some aspects, a network node may detect a signal within a frequency band associated with an altimeter. The network node may perform a measurement associated with the signal. The network node may identify whether the measurement satisfies a threshold. The network node may selectively transmit based at least in part on identifying whether the measurement satisfies the threshold. Numerous other aspects are described.

### CROSS-REFERENCE TO RELATED APPLICATION

This Patent Application claims priority to India patent application Ser. No. 202241037312, filed on Jun. 29, 2022, entitled “PREVENTING ALTIMETER INTERFERENCE,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for preventing altimeter interference.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a network node. The method may include detecting a signal within a frequency band associated with an altimeter. The method may include performing a measurement associated with the signal. The method may include identifying whether the measurement satisfies a threshold. The method may include selectively transmitting based at least in part on identifying whether the measurement satisfies the threshold.

Some aspects described herein relate to an apparatus for wireless communication performed by a network node. The apparatus may include a memory and one or more processors, coupled to the memory. The one or more processors may be configured to detect a signal within a frequency band associated with an altimeter. The one or more processors may be configured to perform a measurement associated with the signal. The one or more processors may be configured to identify whether the measurement satisfies a threshold. The one or more processors may be configured to selectively transmit based at least in part on identifying whether the measurement satisfies the threshold.

Some aspects described herein relate to a non-transitory computer-readable medium that stores a set of instructions for wireless communication by a network node. The set of instructions, when executed by one or more processors of the network node, may cause the network node to detect a signal within a frequency band associated with an altimeter. The set of instructions, when executed by one or more processors of the network node, may cause the network node to perform a measurement associated with the signal. The set of instructions, when executed by one or more processors of the network node, may cause the network node to identify whether the measurement satisfies a threshold. The set of instructions, when executed by one or more processors of the network node, may cause the network node to selectively transmit based at least in part on identifying whether the measurement satisfies the threshold.

Some aspects described herein relate to an apparatus for wireless communication. The apparatus may include means for detecting a signal within a frequency band associated with an altimeter. The apparatus may include means for performing a measurement associated with the signal. The apparatus may include means for identifying whether the measurement satisfies a threshold. The apparatus may include means for selectively transmitting based at least in part on identifying whether the measurement satisfies the threshold.

Aspects generally include a method, apparatus, system, computer program product, non-transitory computer-readable medium, user equipment, base station, network entity, network node, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of altimeter interference, in accordance with the present disclosure.

FIG. 5 is a diagram illustrating an example of preventing altimeter interference, in accordance with the present disclosure.

FIG. 6 is a diagram illustrating an example of a power backoff component, in accordance with the present disclosure.

FIG. 7 is a diagram illustrating examples of operation modes for preventing altimeter interference, in accordance with the present disclosure.

FIG. 8 is a diagram illustrating an example process performed, for example, by a network node, in accordance with the present disclosure.

FIG. 9 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

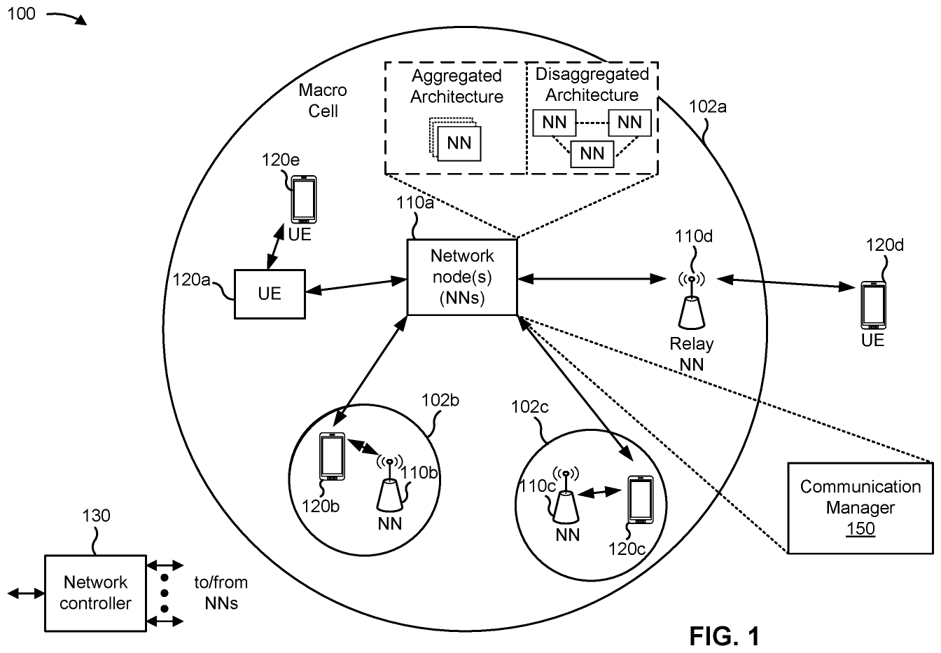

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the network node 110 may include a communication manager 150. As described in more detail elsewhere herein, the communication manager 150 may detect a signal within a frequency band associated with an altimeter; perform a measurement associated with the signal; identify whether the measurement satisfies a threshold; and selectively transmit based at least in part on identifying whether the measurement satisfies the threshold. Additionally, or alternatively, the communication manager 150 may perform one or more other operations described herein.

As indicated above, FIG. 1 is provided as an example. Other examples may differ from what is described with regard to FIG. 1.

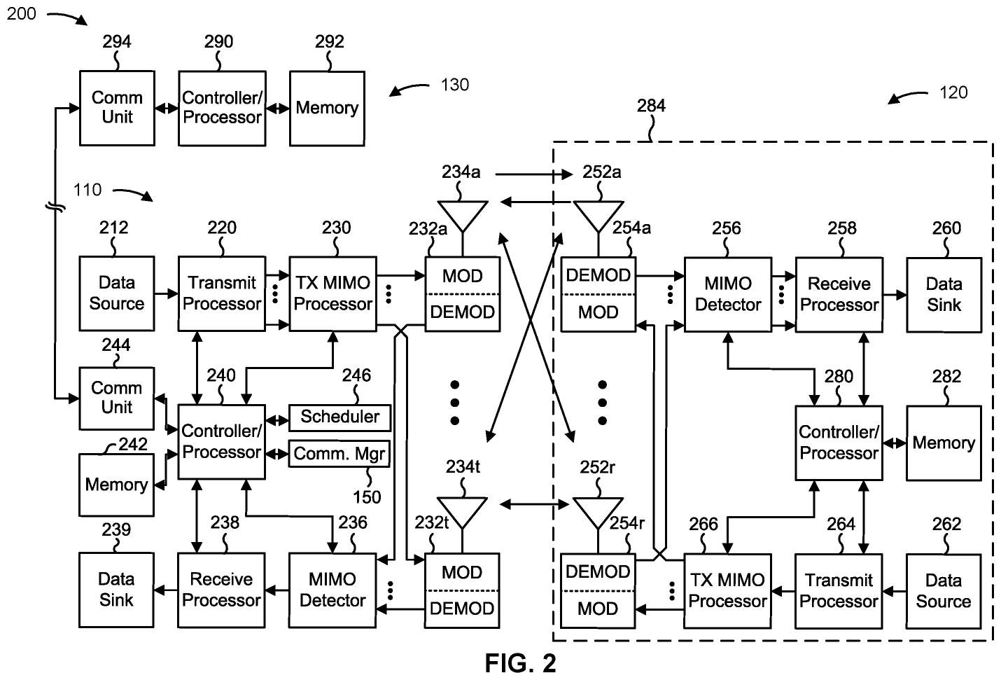

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

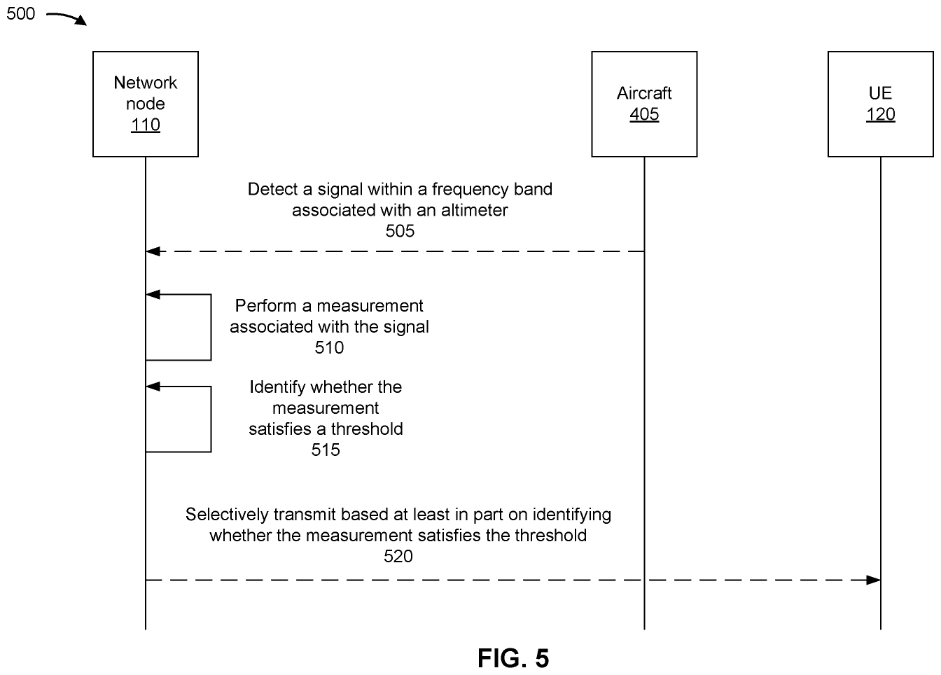

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-9).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-9).

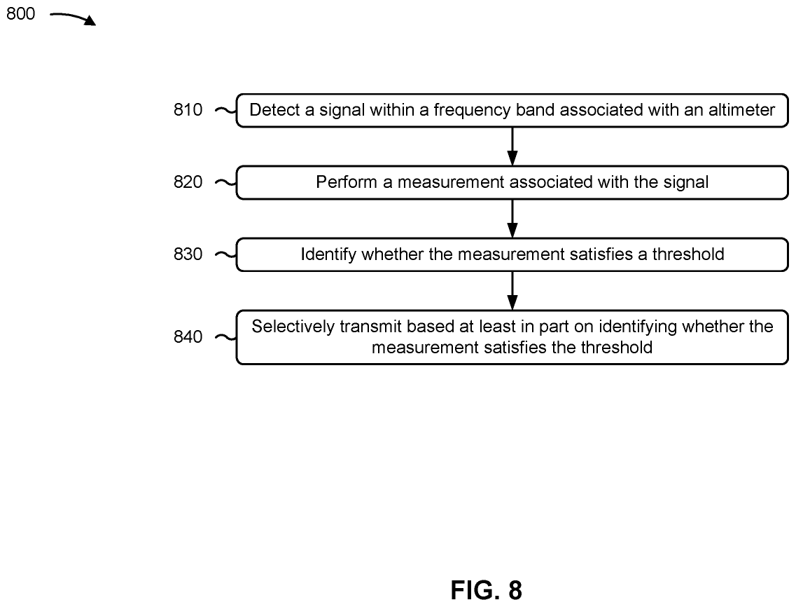

The controller/processor 240 of the network node 110, the controller/processor 280 of the UE 120, and/or any other component(s) of FIG. 2 may perform one or more techniques associated with preventing altimeter interference, as described in more detail elsewhere herein. For example, the controller/processor 240 of the network node 110, the controller/processor 280 of the UE 120, and/or any other component(s) of FIG. 2 may perform or direct operations of, for example, process 800 of FIG. 8, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8, and/or other processes as described herein. In some examples, executing instructions may include running the instructions, converting the instructions, compiling the instructions, and/or interpreting the instructions, among other examples.

In some aspects, the network node 110 includes means for detecting a signal within a frequency band associated with an altimeter; means for performing a measurement associated with the signal; means for identifying whether the measurement satisfies a threshold; and/or means for selectively transmitting based at least in part on identifying whether the measurement satisfies the threshold. In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

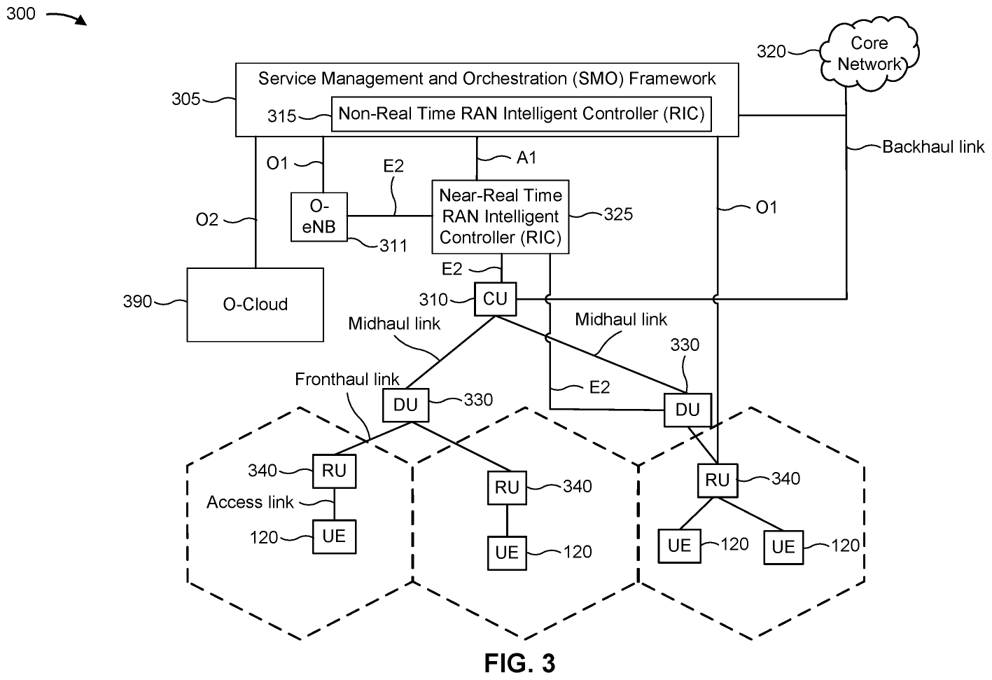

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the non-RT RIC 315 or the Near-RT RIC 325 may be configured to tune RAN behavior or performance. For example, the non-RT RIC 315 may monitor long-term trends and patterns for performance and employ AI/ML models to perform corrective actions through the SMO Framework 305 (such as reconfiguration via an O1 interface) or via creation of RAN management policies (such as Al interface policies).

As indicated above, FIG. 3 is provided as an example. Other examples may differ from what is described with regard to FIG. 3.

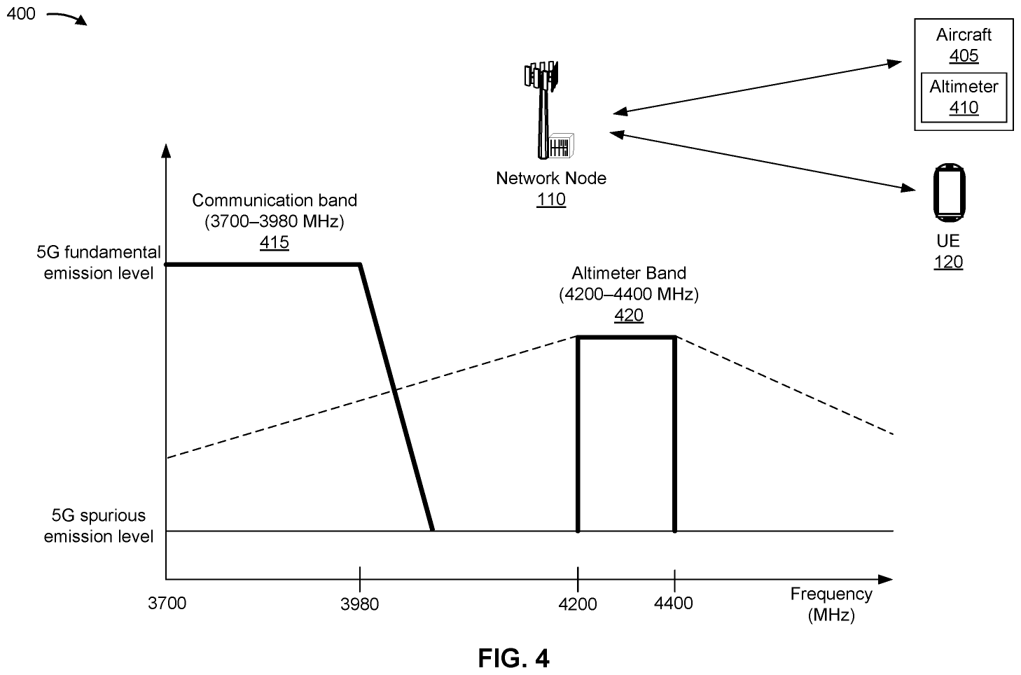

FIG. 4 is a diagram illustrating an example 400 of altimeter interference, in accordance with the present disclosure. The network node 110 may communicate with the UE 120 and the aircraft 405. The aircraft 405 may include some or all of the features of the UE 120. In some cases, the aircraft 405 may be any device that includes an altimeter or that is capable of including an altimeter. In some cases, the aircraft 405 may be an airplane, a helicopter, or a drone, among other examples. In some cases, the aircraft 405 may include the altimeter 410. The altimeter 410 may be used by the aircraft 405 to measure an altitude of the aircraft 405 with respect to a fixed level, such as an altitude of the aircraft 405 with respect to an airport runway or other terrain. In some cases, the network node 110 may be located within a certain distance of the aircraft 405, such as within a certain distance of an airport runway that is to be used by the aircraft 405 for landing purposes. In some cases, the network node 110 communicating with the aircraft 405 may include the network node 110 detecting one or more signals on the RA band associated with the altimeter 420.

As shown in the example 400, the network node 110 may operate within a communication band 415. For example, the network node 110 may communicate with the UE 120 using the communication band 415. The communication band 415 may be a 5G communication band and/or may include a first set of frequencies, such as the frequencies between 3700 MHz and 3980 MHz. In contrast, the altimeter 410 may operate within an altimeter band 420 that includes a second set of frequencies, such as the frequencies between 4200 MHz and 4400 MHz. Note that the above frequencies are provided for example only. For example, the communication band 415 may include any frequencies that are capable of being used by the network node 110 for communication and/or any frequencies that may interfere with the altimeter band 420. In some cases, such as when the network node 110 is located within the certain distance of the airport runway, the altimeter 410 may receive energy that is transmitted in the communication band 415. This may result in interference to the altimeter 410. For example, although buffer zones have been created around some airports, certain scenarios such as emergency landings and drone usage for medical assistance may require a highly sensitive usage of the altimeter 410. The interference to the altimeter 410 may have negative consequences such as increased operation (e.g., landing) difficulties, physical damage to the aircraft 405, and/or injuries or loss of life to passengers of the aircraft 405.

Techniques and apparatuses are described herein for preventing altimeter interference. In some aspects, a network node may detect a signal within a frequency band associated with an altimeter. The network node may perform a measurement associated with the signal, such as determining an energy level associated with the signal. The network node may identify whether the measurement satisfies a threshold, such as an energy threshold. The network node may selectively transmit a communication based at least in part on identifying whether the measurement satisfies the threshold. For example, the network node may transmit a communication based at least in part on identifying that the measurement does not satisfy the threshold. Alternatively, the network node may refrain from transmitting the communication, or may transmit the communication in a select portion of the communication band, based at least in part on identifying that the measurement satisfies the threshold.

As described above, the network node may operate within a communication band that includes a first set of frequencies and the altimeter may operate within an altimeter band that includes a second set of frequencies. In some cases, such as when the network node is located within a certain distance of an airport runway, the altimeter may receive energy that is transmitted in the communication band. This may cause interference to the altimeter. Using the techniques and apparatuses described herein, the network node may selectively transmit a communication based at least in part on identifying whether a signal measurement associated with the altimeter satisfies a threshold. For example, the network node may determine that the altimeter (or the aircraft that includes the altimeter) is within a certain distance of the network node based at least in part on the signal measurement satisfying the threshold. Therefore, the network node may refrain from transmitting a communication that may interfere with the operation of the altimeter, or may transmit the communication in a portion of the communication band that is less likely to interfere with the altimeter. This may reduce the interference to the altimeter, thereby reducing the likelihood of physical damage to the aircraft and/or injuries or loss of life to passengers of the aircraft.

As indicated above, FIG. 4 is provided as an example. Other examples may differ from what is described with regard to FIG. 4.

FIG. 5 is a diagram illustrating an example 500 of preventing altimeter interference, in accordance with the present disclosure. The network node 110 may communicate with one or more UEs, such as the UE 120 and/or the aircraft 405.

As shown in connection with reference number 505, the network node 110 may detect a signal within a frequency band associated with the altimeter. As described herein, the network node 110 may operate within a frequency band, such as the communication band 415, that includes a first set of frequencies, such as the frequencies between 3700 MHz and 3980 MHz. In contrast, the altimeter 410 may operate within another frequency band, such as the altimeter band 420, that includes a second set of frequencies, such as the frequencies between 4200 MHz and 4400 MHz. In some aspects, the network node 110 may be configured to monitor the altimeter band for detecting one or more signals within the altimeter band. In this case, the network node 110 may detect the signal within the altimeter band based at least in part on monitoring the second set of frequencies and detecting the signal within the second set of frequencies.

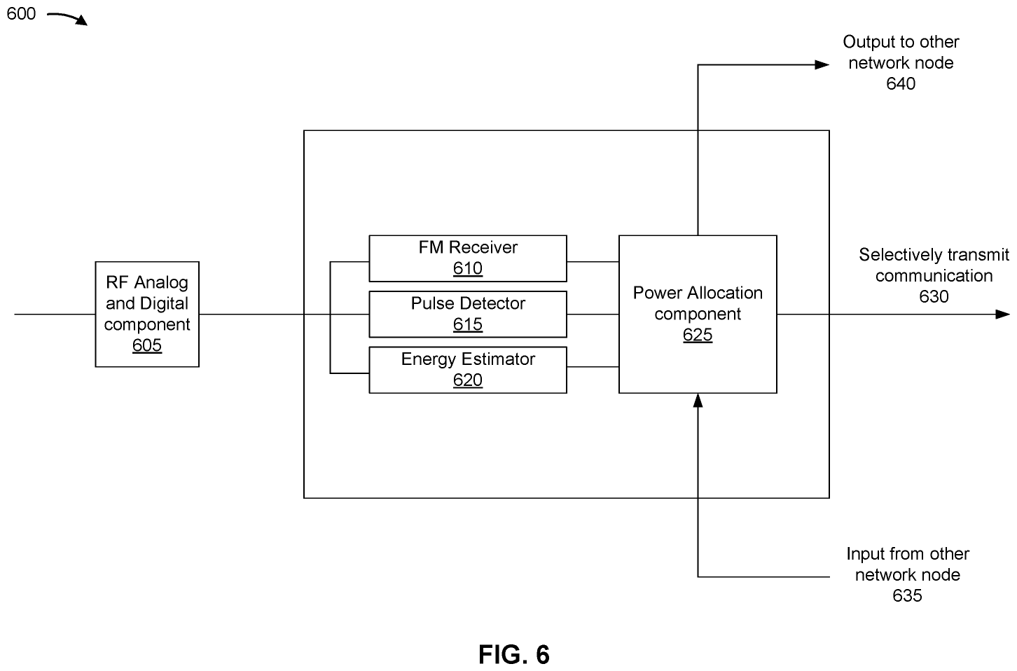

As shown in connection with reference number 510, the network node 110 may perform a measurement associated with the signal. In some aspects, the measurement may be an energy measurement. For example, the network node 110 may measure an energy level associated with the signal. In some aspects, the network node 110 may be configured to perform frequency modulation (FM) detection and/or pulse detection. For example, the network node 110 may detect the signal based at least in part on performing FM detection. Additionally, or alternatively, the network node 110 may detect the signal based at least in part on performing the pulse detection. In some aspects, the network node 110 may perform the energy measurement and may perform at least one of the FM detection and the pulse detection. Additional details regarding these features are described in connection with FIG. 6.

As shown in connection with reference number 515, the network node 110 may identify whether the measurement satisfies a threshold. In some aspects, the threshold may be an energy threshold. For example, the network node 110 may perform the energy measurement associated with the signal and may compare the energy measurement to the energy threshold. In some aspects, the measurement may satisfy the threshold based at least in part on the measurement being greater than, or greater than or equal to, the threshold. Alternatively, the measurement may not satisfy the threshold based at least in part on the measurement being less than, or less than or equal to, the threshold.

As shown in connection with reference number 520, the network node 110 may selectively transmit based at least in part on identifying whether the measurement satisfies the threshold. In some aspects, the network node 110 may determine to transmit a communication and/or may transmit the communication based at least in part on identifying that the measurement does not satisfy the threshold. In some aspects, the measurement not satisfying the threshold may indicate that the aircraft 405 is not within a certain distance (e.g., a threshold distance) of the network node 110. For example, the network node 110 may determine that the aircraft 405 is not within the certain distance of the network node 110 based at least in part on the energy measurement associated with the signal not satisfying the energy threshold. In this case, the communication by the network node 110 is not likely to interfere with the altimeter 410 associated with the aircraft 405. Thus, the network node 110 may transmit the communication based at least in part on the communication having a reduced likelihood (or no likelihood) of interfering with the altimeter 410.

In some aspects, the network node 110 may determine not to transmit a communication and/or may refrain from transmitting the communication based at least in part on identifying that the measurement satisfies the threshold. In some aspects, the measurement satisfying the threshold may indicate that the aircraft 405 is within the certain distance (e.g., the threshold distance) of the network node 110. For example, the network node 110 may determine that the aircraft 405 is within the certain distance of the network node 110 based at least in part on the energy measurement associated with the signal satisfying the energy threshold. In this case, the communication by the network node 110 may be more likely to interfere with the altimeter 410 associated with the aircraft 405. Thus, the network node 110 may refrain from transmitting (e.g., may not transmit) the communication based at least in part on the communication having the increased likelihood of interfering with the altimeter 410. In some aspects, the network node 110 may refrain from transmitting the communication for a period, such as until another measurement associated with the signal (or another measurement associated with another signal) does not satisfy the threshold. For example, the network node 110 may perform the other measurement, may compare the other measurement to the threshold, and may transmit the communication based at least in part on the other measurement not satisfying the threshold. In some aspects, the other measurement not satisfying the threshold may indicate that the aircraft 405 is no longer within the certain distance of the network node 110 and that the communication is not likely to interfere with the altimeter 410.

In some aspects, the network node 110 may transmit the communication using a portion of the communication band. For example, the network node 110 may transmit the communication using only the portion of the communication band based at least in part on identifying that the measurement satisfies the threshold. In some aspects, the portion of the communication band may include a portion of the frequencies associated with the communication band that are not close to the frequencies associated with altimeter band. For example, the communication band may include the frequencies from 3700 MHz to 3980 MHz, whereas the portion of the communication band may only include the frequencies from 3700 MHz to 3900 MHz. In this case, the network node 110 may not transmit within the frequencies 3901 MHz to 3980 MHz since these frequencies may be more likely to interfere with the altimeter band.

In some aspects, the portion of the communication band may be based at least in part on the energy measurement. For example, the network node 110 may adjust the portion of the communication band based at least in part on the energy measurement. In one example, the network node 110 may transmit the communication within a first portion (e.g., 3700 MHz to 3900 MHz) of the communication band based at least in part on the measurement being a first energy measurement, or may transmit the communication within a second portion (e.g., a smaller portion) of the frequency band (e.g., 3700 MHz to 3800 MHz) based at least in part on the measurement being a second energy measurement that is greater than the first energy measurement. In some aspects, the network node 110 may gradually decrease the frequency range associated with the portion of the communication band based at least in part on the energy measurement being a higher energy measurement and/or may gradually increase the frequency range associated with the portion of the communication band based at least in part on the energy measurement being a lower energy measurement.

In some aspects, the network node 110 may transmit the communication based at least in part on a combination of the FM detection, the pulse detection, and the energy measurement. For example, the network node 110 may determine that the aircraft 405 is within an area (e.g., the threshold distance) of the network node 110 based at least in part on using the FM detection and/or the pulse detection. If the FM detection or the pulse detection do not detect that the aircraft 405 is within the area of the network node 110, the network node 110 may transmit one or more communications. However, if the FM detection or the pulse detection detect that the aircraft 405 is within the area of the network node 110, the network node 110 may not transmit the communication and/or may adjust the portion of the communication band based at least in part on the energy measurement, as described herein.

In some aspects, the network node 110 may operate in a standalone mode. For example, as described herein, the network node 110 may transmit a communication, may refrain from transmitting the communication, or may transmit the communication within a select portion of the communication band, based at least in part on detecting the signal within the altimeter band and comparing a measurement of the signal to a threshold. The network node 110 may perform these functions without receiving any input from other network nodes.

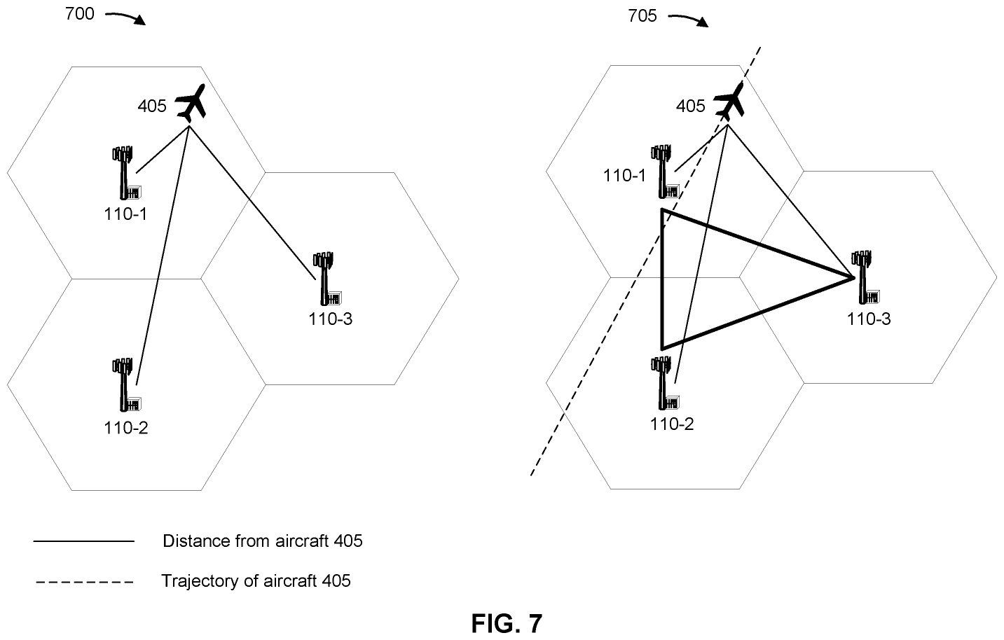

In some aspects, the network node 110 may operate in a collaborative mode. In this case, the network node 110 may receive an input from one or more other network nodes. The input from the one or more other network nodes may include another signal, another measurement associated with the other signal, and/or may be an indication of whether or not to transmit a communication. In some aspects, the network node 110 may determine a trajectory of the aircraft 405 based at least in part on the input from the one or more other network nodes. For example, the network node 110 may receive a first input from a first other network node and may receive a second input from a second other network node. The network node 110 may determine the trajectory of the aircraft 405 based at least in part on the first input and the second input. Additional details regarding these features are described in connection with FIG. 7.

In some aspects, the network node 110 may transmit a communication based at least in part on the trajectory indicating that the aircraft 405 is not within the area of the network node 110 and/or that the aircraft 405 is moving in a direction that is not toward the network node 110. Alternatively, the network node 110 may refrain from transmitting the communication, or may only transmit the communication within the portion of the communication band, based at least in part on the trajectory indicating that the aircraft 405 is within the area of the network node 110 and/or that the aircraft 405 is moving in a direction that is toward the network node 110. In some aspects, the network node 110 may selectively transmit the communication based at least in part on identifying whether the measurement satisfies the threshold and based at least in part on the input from the one or more other network nodes. For example, the network node 110 may transmit the communication based at least in part on the measurement not satisfying the threshold and/or based at least in part on the trajectory indicating that the aircraft 405 is not within the area of the network node 110 or that the aircraft 405 is moving in a direction that is not toward the network node 110. Alternatively, the network node 110 may refrain from transmitting the communication, or may only transmit the communication within the portion of the communication band, based at least in part on the measurement satisfying the threshold and/or based at least in part on the trajectory indicating that the aircraft 405 is within the area of the network node 110 or that the aircraft 405 is moving in a direction that is toward the network node 110.

In some aspects, the network node 110 may transmit an output to one or more other network nodes that may enable the one or more other network nodes to determine whether or not to transmit a communication. For example, the output may include an indication of the signal, an indication of the measurement associated with the signal, and/or an indication of whether or not to perform the transmission. In some aspects, the network node 110 (and/or the other network nodes) may selectively transmit based at least in part on a beam direction. For example, the network node 110 may transmit based at least in part on the network node 110 having a beam that is pointing away from the aircraft 405 or may not transmit based at least in part on the network node 110 having a beam that is pointing toward the aircraft 405. In some aspects, a precoding matrix may indicate a beam direction of a plurality of network nodes and/or whether each of the plurality of network nodes should be able to transmit at a given time.

As described above, the network node 110 may operate within a communication band that includes a first set of frequencies and the altimeter 410 may operate within an altimeter band that includes a second set of frequencies. In some cases, such as when the network node 110 is located within a certain distance of an airport runway, the altimeter 410 may receive energy that is transmitted in the communication band. This may cause interference to the altimeter 410. Using the techniques and apparatuses described herein, the network node 110 may selectively transmit a communication based at least in part on identifying whether a signal measurement associated with the altimeter 410 satisfies a threshold. For example, the network node 110 may determine that the altimeter (or the aircraft 405 that includes the altimeter) is within a certain distance of the network node 110 based at least in part on the signal measurement satisfying the threshold. Therefore, the network node 110 may refrain from transmitting a communication that may interfere with the operation of the altimeter 410, or may transmit the communication in a portion of the communication band that is less likely to interfere with the altimeter 410. This may reduce the interference to the altimeter 410, thereby reducing the likelihood of the physical damage to the aircraft 405 and/or the injuries or loss of life to the passengers of the aircraft 405.

As indicated above, FIG. 5 is provided as an example. Other examples may differ from what is described with regard to FIG. 5.

FIG. 6 is a diagram illustrating an example of a power backoff component 600, in accordance with the present disclosure. The power backoff component 600 may include an RF analog and digital component 605, an FM receiver 610, a pulse detector 615, an energy estimator 620, and/or a power allocation component 625, among other examples. In some aspects, the power backoff component 600 may be included in a network node, such as the network node 110. The RF analog and digital component 605 may be configured to monitor (e.g., sample) an aviation band (such as the altimeter band 420) for detecting one or more signals associated with an altimeter, such as the altimeter 410 associated with the aircraft 405. The FM receiver 610 may be configured to perform frequency demodulation, such as frequency modulated continuous wave (FMCW) demodulation. In some aspects, the FM receiver 610 may be configured to determine an altitude of the aircraft 405 with a small fixed error, but may be less accurate at higher altitudes than other components (such as the pulse detector 615). The pulse detector 615 may be configured to detect one or more pulses, and may determine an altitude of the aircraft 405 using the following example formula: t₀=(2*h)/c₀, where t₀ is a delay time, h is a height above ground, and c₀ is a constant such as a speed of light. In some aspects, the pulse detector 615 may calculate an altitude of the aircraft 405 with less overall accuracy (e.g., compared to the FM receiver 610) but may be more accurate from higher altitudes. The energy estimator 620 may be configured to estimate (e.g., measure) an energy level of a signal, such as a signal received within the altimeter band 420. In some aspects, the power backoff component 600 may include one or more of the FM receiver 610, the pulse detector 615, and the energy estimator 620. In one example, the power backoff component 600 may include only the energy estimator 620. In another example, the power backoff component 600 may include the energy estimator 620 and one of the FM receiver 610 or the pulse detector 615. In another example, the power backoff component 600 may include all three of the FM receiver 610, the pulse detector 615, and the energy estimator 620.

In some aspects, as shown by reference number 630, the power allocation component 625 may be configured to selectively transmit a communication. For example, the power allocation component 625 may transmit a communication based at least in part on a signal measurement not satisfying a threshold, as described herein. Alternatively, the power allocation component 625 may refrain from transmitting the communication, or may only transmit the communication within a select portion of the communication band, based at least in part on the signal measurement satisfying the threshold.

In some aspects, as shown by reference number 635, the power allocation component 625 may receive an input from one or more other network nodes. In some aspects, the power allocation component 625 may determine a trajectory of the aircraft 405 based at least in part on the input from the one or more other network nodes. The power allocation component 625 may selectively transmit a communication based at least in part on the trajectory of the aircraft 405 (and/or based at least in part on the signal measurement satisfying the threshold). In some aspects, the input may include another signal, another measurement associated with the other signal, and/or may be an indication of whether or not to transmit a communication. In some aspects, as shown by reference number 640, the power allocation component 625 may transmit an output to one or more other network nodes. The output may include an indication of the signal, an indication of the measurement associated with the signal, and/or an indication of whether or not to perform the transmission, among other examples.

As indicated above, FIG. 6 is provided as an example. Other examples may differ from what is described with regard to FIG. 6.

FIG. 7 is a diagram illustrating examples 700 and 705 of operation modes for preventing altimeter interference, in accordance with the present disclosure. One or more network nodes 110, such as the network node 110-1, the network node 110-2, and/or the network node 110-3 may be configured to determine a distance of the aircraft 405 from the respective network node.

As shown in the example 700, the one or more network nodes 110 may operate in the standalone mode. As described herein, the one or more network nodes 110 may receive a signal within an altimeter band, perform a measurement associated with the signal, compare the measurement to a threshold, and selectively transmit a communication (e.g., to a UE 120) based at least in part on the measurement satisfying the threshold. For example, the network node 110 may transmit the communication based at least in part on identifying that the measurement does not satisfy the threshold. Alternatively, the network node 110 may refrain from transmitting the communication, or may transmit the communication in a select portion of the communication band, based at least in part on identifying that the measurement satisfies the threshold. In some aspects, one or more of the network nodes 110 may determine a distance of the aircraft 405 from the respective network node 110 based at least in part on the signal. For example, the network node 110-1 may determine a distance of the aircraft 405 from the network node 110-1 based at least in part on the energy measurement associated with the signal.

As shown in the example 705, the one or more network nodes 110 may operate in a collaborative mode. In the collaborative mode, each of the network nodes 110 may be configured to determine the distance of the aircraft 405 from the respective network node 110. Additionally, or alternatively, one or more of the network nodes 110 may be configured to determine a trajectory of the aircraft 405. For example, the network node 110-1 may receive an input from the other network nodes. The input from the other network nodes may include another signal, another measurement associated with the other signal, and/or may be an indication of whether or not to transmit a communication. In some aspects, the network node 110-1 may determine the trajectory of the aircraft 405 based at least in part on the input from the other network nodes. For example, the network node 110 may receive a first input from a first other network node 110-2 and may receive a second input from a second other network node 110-3. The network node 110-1 may determine the trajectory of the aircraft 405 based at least in part on the first input and the second input. For example, the network node 110-1 may determine the trajectory of the aircraft 405 based at least in part on a combination of the signal (or the signal measurement) detected at the network node 110-1, the first input, and the second input.

As indicated above, FIG. 7 is provided as an example. Other examples may differ from what is described with regard to FIG. 7.

FIG. 8 is a diagram illustrating an example process 800 performed, for example, by a network node, in accordance with the present disclosure. Example process 800 is an example where the network node (e.g., network node 110) performs operations associated with preventing altimeter interference.

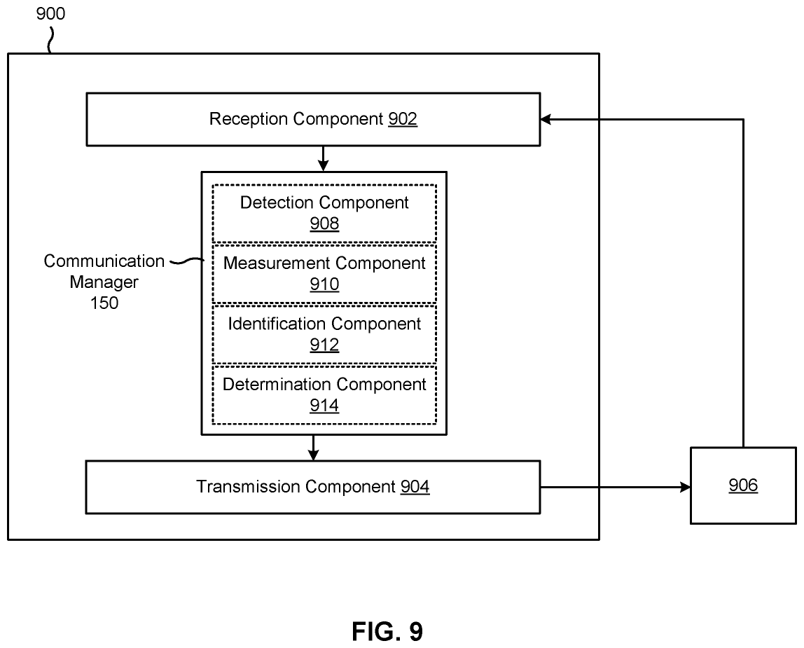

As shown in FIG. 8, in some aspects, process 800 may include detecting a signal within a frequency band associated with an altimeter (block 810). For example, the network node (e.g., using communication manager 150 and/or detection component 908, depicted in FIG. 9) may detect (e.g., using antenna 234, DEMOD 232, MIMO detector 236, receive processor 238, controller/processor 240, antenna 252, DEMOD 254, MIMO detector 256, receive processor 258, controller/processor 280, and/or the like) a signal within a frequency band associated with an altimeter, as described above.

As further shown in FIG. 8, in some aspects, process 800 may include performing a measurement associated with the signal (block 820). For example, the network node (e.g., using communication manager 150 and/or measurement component 910, depicted in FIG. 9) may perform a measurement (e.g., using controller/processor 240, controller/processor 280, and/or the like) associated with the signal, as described above.

As further shown in FIG. 8, in some aspects, process 800 may include identifying whether the measurement satisfies a threshold (block 830). For example, the network node (e.g., using communication manager 150 and/or identification component 912, depicted in FIG. 9) may identify (e.g., using controller/processor 240, controller/processor 280, and/or the like) whether the measurement satisfies a threshold, as described above.

As further shown in FIG. 8, in some aspects, process 800 may include selectively transmitting based at least in part on identifying whether the measurement satisfies the threshold (block 840). For example, the network node (e.g., using communication manager 150 and/or transmission component 904, depicted in FIG. 9) may selectively transmit (e.g., using controller/processor 240, transmit processor 220, TX MIMO processor 230, MOD 232, antenna 234, controller/processor 280, transmit processor 264, TX MIMO processor 266, MOD 254, antenna 252, and/or the like) based at least in part on identifying whether the measurement satisfies the threshold, as described above.

Process 800 may include additional aspects, such as any single aspect or any combination of aspects described below and/or in connection with one or more other processes described elsewhere herein.

In a first aspect, selectively transmitting based at least in part on identifying whether the measurement satisfies the threshold comprises transmitting a communication based at least in part on identifying that the measurement does not satisfy the threshold.

In a second aspect, alone or in combination with the first aspect, selectively transmitting based at least in part on identifying whether the measurement satisfies the threshold comprises refraining from transmitting a communication based at least in part on identifying that the measurement satisfies the threshold.

In a third aspect, alone or in combination with one or more of the first and second aspects, refraining from transmitting the communication comprises delaying a transmission of the communication until another measurement, associated with another signal that is detected within the frequency band, satisfies the threshold.

In a fourth aspect, alone or in combination with one or more of the first through third aspects, the threshold is an energy threshold, and performing the measurement comprises determining an energy level associated with the signal.

In a fifth aspect, alone or in combination with one or more of the first through fourth aspects, detecting the signal comprises performing a frequency modulation detection or a pulse detection.

In a sixth aspect, alone or in combination with one or more of the first through fifth aspects, process 800 includes identifying (e.g., using controller/processor 240, controller/processor 280, and/or the like) a transmission band associated with the network node, wherein selectively transmitting comprises transmitting within a select portion of the transmission band based at least in part on identifying that the measurement satisfies the threshold.

In a seventh aspect, alone or in combination with one or more of the first through sixth aspects, transmitting within the select portion of the transmission band comprises transmitting within a first portion of the transmission band that is further from the frequency band associated with the altimeter and refraining from transmitting within a second portion of the transmission band that is closer to the frequency band associated with the altimeter.

In an eighth aspect, alone or in combination with one or more of the first through seventh aspects, the transmission band is 3.7 gigahertz (GHz) to 3.98 GHz.

In a ninth aspect, alone or in combination with one or more of the first through eighth aspects, the frequency band associated with the altimeter is 4.2 gigahertz (GHz) to 4.4 GHz.

In a tenth aspect, alone or in combination with one or more of the first through ninth aspects, process 800 includes receiving (e.g., using antenna 234, DEMOD 232, MIMO detector 236, receive processor 238, controller/processor 240, antenna 252, DEMOD 254, MIMO detector 256, receive processor 258, controller/processor 280, and/or the like), from another network node, an input that is based at least in part on the signal or another signal associated with the altimeter, and identifying, based at least in part on the input, a trajectory of an aircraft that includes the altimeter, and selectively transmitting comprises selectively transmitting based at least in part on identifying whether the measurement satisfies the threshold and based at least in part on identifying the trajectory of the aircraft.

In an eleventh aspect, alone or in combination with one or more of the first through tenth aspects, selectively transmitting comprises transmitting a communication based at least in part on the measurement not satisfying the threshold and based at least in part on the trajectory of the aircraft indicating that the communication will not interfere with the altimeter.

In a twelfth aspect, alone or in combination with one or more of the first through eleventh aspects, selectively transmitting comprises refraining from transmitting a communication, or transmitting the communication in a select portion of a transmission band, based at least in part on the measurement satisfying the threshold and based at least in part on the trajectory of the aircraft indicating that the communication will interfere with the altimeter.

In a thirteenth aspect, alone or in combination with one or more of the first through twelfth aspects, receiving the input from the other network node comprises receiving a first input from a first other network node and receiving a second input from a second other network node, and identifying the trajectory of the aircraft comprises identifying the trajectory of the aircraft based at least in part on the first input and the second input.

In a fourteenth aspect, alone or in combination with one or more of the first through thirteenth aspects, the input includes another signal associated with the altimeter, another measurement that is based at least in part on the other signal associated with the altimeter, or an indication of whether or not to transmit a communication.

In a fifteenth aspect, alone or in combination with one or more of the first through fourteenth aspects, process 800 includes transmitting (e.g., using controller/processor 240, transmit processor 220, TX MIMO processor 230, MOD 232, antenna 234, controller/processor 280, transmit processor 264, TX MIMO processor 266, MOD 254, antenna 252, and/or the like), to another network node, an indication of the signal, an indication of the measurement associated with the signal, or an indication of whether or not to transmit a communication based at least in part on the measurement associated with the signal.

In a sixteenth aspect, alone or in combination with one or more of the first through fifteenth aspects, process 800 includes determining (e.g., using controller/processor 240, controller/processor 280, and/or the like) that an aircraft associated with the altimeter is within a distance of the network node based at least in part on identifying that the measurement satisfies the threshold, or determining that the aircraft associated with the altimeter is not within the distance of the network node based at least in part on identifying that the measurement does not satisfy the threshold.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a network node, or a network node may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 150. The communication manager 150 may include one or more of a detection component 908, a measurement component 910, an identification component 912, or a determination component 914, among other examples.

In some aspects, the apparatus 900 may be configured to perform one or more operations described herein in connection with FIGS. 5-7. Additionally, or alternatively, the apparatus 900 may be configured to perform one or more processes described herein, such as process 800 of FIG. 8. In some aspects, the apparatus 900 and/or one or more components shown in FIG. 9 may include one or more components of the network node described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the network node described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the network node described in connection with FIG. 2. In some aspects, the transmission component 904 may be co-located with the reception component 902 in a transceiver.

The detection component 908 may detect a signal within a frequency band associated with an altimeter. The measurement component 910 may perform a measurement associated with the signal. The identification component 912 may identify whether the measurement satisfies a threshold. The transmission component 904 may selectively transmit based at least in part on identifying whether the measurement satisfies the threshold.

The identification component 912 may identify a transmission band associated with the network node, wherein selectively transmitting comprises transmitting within a select portion of the transmission band based at least in part on identifying that the measurement satisfies the threshold.

The reception component 902 may receive, from another network node, an input that is based at least in part on the signal or another signal associated with the altimeter. The identification component 912 may identify, based at least in part on the input, a trajectory of an aircraft that includes the altimeter, wherein selectively transmitting comprises selectively transmitting based at least in part on identifying whether the measurement satisfies the threshold and based at least in part on identifying the trajectory of the aircraft. The transmission component 904 may transmit, to another network node, an indication of the signal, an indication of the measurement associated with the signal, or an indication of whether or not to transmit a communication based at least in part on the measurement associated with the signal.

The determination component 914 may determine that an aircraft associated with the altimeter is within a distance of the network node based at least in part on identifying that the measurement satisfies the threshold. The determination component 914 may determine that the aircraft associated with the altimeter is not within the distance of the network node based at least in part on identifying that the measurement does not satisfy the threshold.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a network node, comprising: detecting a signal within a frequency band associated with an altimeter; performing a measurement associated with the signal; identifying whether the measurement satisfies a threshold; and selectively transmitting based at least in part on identifying whether the measurement satisfies the threshold.

Aspect 2: The method of Aspect 1, wherein selectively transmitting based at least in part on identifying whether the measurement satisfies the threshold comprises transmitting a communication based at least in part on identifying that the measurement does not satisfy the threshold.

Aspect 3: The method of any of Aspects 1-2, wherein selectively transmitting based at least in part on identifying whether the measurement satisfies the threshold comprises refraining from transmitting a communication based at least in part on identifying that the measurement satisfies the threshold.

Aspect 4: The method of Aspect 3, wherein refraining from transmitting the communication comprises delaying a transmission of the communication until another measurement, associated with another signal that is detected within the frequency band, satisfies the threshold.

Aspect 5: The method of any of Aspects 1-4, wherein the threshold is an energy threshold, and wherein performing the measurement comprises determining an energy level associated with the signal.

Aspect 6: The method of any of Aspects 1-5, wherein detecting the signal comprises performing a frequency modulation detection or a pulse detection.

Aspect 7: The method of any of Aspects 1-6, further comprising identifying a transmission band associated with the network node, wherein selectively transmitting comprises transmitting within a select portion of the transmission band based at least in part on identifying that the measurement satisfies the threshold.

Aspect 8: The method of Aspect 7, wherein transmitting within the select portion of the transmission band comprises transmitting within a first portion of the transmission band that is further from the frequency band associated with the altimeter and refraining from transmitting within a second portion of the transmission band that is closer to the frequency band associated with the altimeter.

Aspect 9: The method of Aspect 7, wherein the transmission band is 3.7 gigahertz (GHz) to 3.98 GHz.

Aspect 10: The method any of Aspects 1-9, wherein the frequency band associated with the altimeter is 4.2 gigahertz (GHz) to 4.4 GHz.

Aspect 11: The method of any of Aspects 1-10, further comprising: receiving, from another network node, an input that is based at least in part on the signal or another signal associated with the altimeter; and identifying, based at least in part on the input, a trajectory of an aircraft that includes the altimeter, wherein selectively transmitting comprises selectively transmitting based at least in part on identifying whether the measurement satisfies the threshold and based at least in part on identifying the trajectory of the aircraft.

Aspect 12: The method of Aspect 11, wherein selectively transmitting comprises transmitting a communication based at least in part on the measurement not satisfying the threshold and based at least in part on the trajectory of the aircraft indicating that the communication will not interfere with the altimeter.

Aspect 13: The method of Aspect 11, wherein selectively transmitting comprises refraining from transmitting a communication, or transmitting the communication in a select portion of a transmission band, based at least in part on the measurement satisfying the threshold and based at least in part on the trajectory of the aircraft indicating that the communication will interfere with the altimeter.

Aspect 14: The method of Aspect 11, wherein receiving the input from the other network node comprises receiving a first input from a first other network node and receiving a second input from a second other network node, and wherein identifying the trajectory of the aircraft comprises identifying the trajectory of the aircraft based at least in part on the first input and the second input.

Aspect 15: The method of Aspect 11, wherein the input includes another signal associated with the altimeter, another measurement that is based at least in part on the other signal associated with the altimeter, or an indication of whether or not to transmit a communication.

Aspect 16: The method of any of Aspects 1-15, further comprising transmitting, to another network node, an indication of the signal, an indication of the measurement associated with the signal, or an indication of whether or not to transmit a communication based at least in part on the measurement associated with the signal.

Aspect 17: The method of any of Aspects 1-16, further comprising: determining that an aircraft associated with the altimeter is within a distance of the network node based at least in part on identifying that the measurement satisfies the threshold; or determining that the aircraft associated with the altimeter is not within the distance of the network node based at least in part on identifying that the measurement does not satisfy the threshold.

Aspect 18: An apparatus for wireless communication at a device, comprising a processor; memory coupled with the processor; and instructions stored in the memory and executable by the processor to cause the apparatus to perform the method of one or more of Aspects 1-17.

Aspect 19: A device for wireless communication, comprising a memory and one or more processors coupled to the memory, the one or more processors configured to perform the method of one or more of Aspects 1-17.

Aspect 20: An apparatus for wireless communication, comprising at least one means for performing the method of one or more of Aspects 1-17.

Aspect 21: A non-transitory computer-readable medium storing code for wireless communication, the code comprising instructions executable by a processor to perform the method of one or more of Aspects 1-17.

Aspect 22: A non-transitory computer-readable medium storing a set of instructions for wireless communication, the set of instructions comprising one or more instructions that, when executed by one or more processors of a device, cause the device to perform the method of one or more of Aspects 1-17.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a network node, comprising:
a memory; and
one or more processors, coupled to the memory, configured to:
detect a signal within a frequency band associated with an altimeter;
perform a measurement associated with the signal;
identify whether the measurement satisfies a threshold; and
selectively transmit based at least in part on identifying whether the measurement satisfies the threshold.

2. The apparatus of claim 1, wherein the one or more processors, to selectively transmit based at least in part on identifying whether the measurement satisfies the threshold, are configured to transmit a communication based at least in part on identifying that the measurement does not satisfy the threshold.

3. The apparatus of claim 1, wherein the one or more processors, to selectively transmit based at least in part on identifying whether the measurement satisfies the threshold, are configured to refrain from transmitting a communication based at least in part on identifying that the measurement satisfies the threshold.

4. The apparatus of claim 3, wherein the one or more processors, to refrain from transmitting the communication, are configured to delay a transmission of the communication until another measurement, associated with another signal that is detected within the frequency band, satisfies the threshold.

5. The apparatus of claim 1, wherein the threshold is an energy threshold, and wherein performing the measurement comprises determining an energy level associated with the signal.

6. The apparatus of claim 1, wherein the one or more processors, to detect the signal, are configured to perform a frequency modulation detection or a pulse detection.

7. The apparatus of claim 1, wherein the one or more processors are further configured to identify a transmission band associated with the network node, wherein selectively transmitting comprises transmitting within a select portion of the transmission band based at least in part on identifying that the measurement satisfies the threshold.

8. The apparatus of claim 7, wherein the one or more processors, to transmit within the select portion of the transmission band, are configured to transmit within a first portion of the transmission band that is further from the frequency band associated with the altimeter and refrain from transmitting within a second portion of the transmission band that is closer to the frequency band associated with the altimeter.

9. The apparatus of claim 1, wherein the frequency band associated with the altimeter is 4.2 gigahertz (GHz) to 4.4 GHz.

10. The apparatus of claim 1, wherein the one or more processors are further configured to:
receive, from another network node, an input that is based at least in part on the signal or another signal associated with the altimeter; and
identify, based at least in part on the input, a trajectory of an aircraft that includes the altimeter,
wherein the one or more processors, to selectively transmit, are configured to selectively transmit based at least in part on identifying whether the measurement satisfies the threshold and based at least in part on identifying the trajectory of the aircraft.

11. The apparatus of claim 10, wherein the one or more processors, to selectively transmit, are configured to transmit a communication based at least in part on the measurement not satisfying the threshold and based at least in part on the trajectory of the aircraft indicating that the communication will not interfere with the altimeter.

12. The apparatus of claim 10, wherein the one or more processors, to selectively transmit, are configured to refrain from transmitting a communication, or transmit the communication in a select portion of a transmission band, based at least in part on the measurement satisfying the threshold and based at least in part on the trajectory of the aircraft indicating that the communication will interfere with the altimeter.

13. The apparatus of claim 10, wherein receiving the input from the other network node comprises receiving a first input from a first other network node and receiving a second input from a second other network node, and wherein identifying the trajectory of the aircraft comprises identifying the trajectory of the aircraft based at least in part on the first input and the second input.

14. The apparatus of claim 10, wherein the input includes another signal associated with the altimeter, another measurement that is based at least in part on the other signal associated with the altimeter, or an indication of whether or not to transmit a communication.

15. The apparatus of claim 1, wherein the one or more processors are further configured to transmit, to another network node, an indication of the signal, an indication of the measurement associated with the signal, or an indication of whether or not to transmit a communication based at least in part on the measurement associated with the signal.

16. The apparatus of claim 1, wherein the one or more processors are further configured to:
determine that an aircraft associated with the altimeter is within a distance of the network node based at least in part on identifying that the measurement satisfies the threshold; or
determine that the aircraft associated with the altimeter is not within the distance of the network node based at least in part on identifying that the measurement does not satisfy the threshold.

17. A method of wireless communication performed by a network node, comprising:
detecting a signal within a frequency band associated with an altimeter;
performing a measurement associated with the signal;
identifying whether the measurement satisfies a threshold; and
selectively transmitting based at least in part on identifying whether the measurement satisfies the threshold.

18. The method of claim 17, wherein selectively transmitting based at least in part on identifying whether the measurement satisfies the threshold comprises:
transmitting a communication based at least in part on identifying that the measurement does not satisfy the threshold; or
refraining from transmitting the communication based at least in part on identifying that the measurement satisfies the threshold.

19. The method of claim 18, wherein refraining from transmitting the communication comprises delaying a transmission of the communication.

20. The method of claim 17, wherein the threshold is an energy threshold, and wherein performing the measurement comprises determining an energy level associated with the signal.

21. The method of claim 17, further comprising identifying a transmission band associated with the network node, wherein selectively transmitting comprises transmitting within a select portion of the transmission band based at least in part on identifying that the measurement satisfies the threshold.

22. The method of claim 17, further comprising:
receiving, from another network node, an input that is based at least in part on the signal or another signal associated with the altimeter; and
identifying, based at least in part on the input, a trajectory of an aircraft that includes the altimeter,
wherein selectively transmitting comprises selectively transmitting based at least in part on identifying whether the measurement satisfies the threshold and based at least in part on identifying the trajectory of the aircraft.

23. The method of claim 22, wherein selectively transmitting comprises:
transmitting a communication based at least in part on the measurement not satisfying the threshold and based at least in part on the trajectory of the aircraft indicating that the communication will not interfere with the altimeter; or
refraining from transmitting the communication, or transmitting the communication in a select portion of a transmission band, based at least in part on the measurement satisfying the threshold and based at least in part on the trajectory of the aircraft indicating that the communication will interfere with the altimeter.

24. The method of claim 22, wherein receiving the input from the other network node comprises receiving a first input from a first other network node and receiving a second input from a second other network node, and wherein identifying the trajectory of the aircraft comprises identifying the trajectory of the aircraft based at least in part on the first input and the second input.

25. The method of claim 17, further comprising transmitting, to another network node, an indication of the signal, an indication of the measurement associated with the signal, or an indication of whether or not to transmit a communication based at least in part on the measurement associated with the signal.

26. The method of claim 17, further comprising:
determining that an aircraft associated with the altimeter is within a distance of the network node based at least in part on identifying that the measurement satisfies the threshold; or
determining that the aircraft associated with the altimeter is not within the distance of the network node based at least in part on identifying that the measurement does not satisfy the threshold.

27. A non-transitory computer-readable medium storing a set of instructions for wireless communication, the set of instructions comprising:
one or more instructions that, when executed by one or more processors of a network node, cause the network node to:
detect a signal within a frequency band associated with an altimeter;
perform a measurement associated with the signal;
identify whether the measurement satisfies a threshold; and
selectively transmit based at least in part on identifying whether the measurement satisfies the threshold.

28. The non-transitory computer-readable medium of claim 27, wherein the one or more instructions, that cause the network node to selectively transmit based at least in part on identifying whether the measurement satisfies the threshold, cause the network node to:
transmit a communication based at least in part on identifying that the measurement does not satisfy the threshold; or
refrain from transmitting the communication based at least in part on identifying that the measurement satisfies the threshold.

29. An apparatus for wireless communication, comprising:
means for detecting a signal within a frequency band associated with an altimeter;
means for performing a measurement associated with the signal;
means for identifying whether the measurement satisfies a threshold; and
means for selectively transmitting based at least in part on identifying whether the measurement satisfies the threshold.

30. The apparatus of claim 29, wherein the means for selectively transmitting based at least in part on identifying whether the measurement satisfies the threshold comprises means for:
transmitting a communication based at least in part on identifying that the measurement does not satisfy the threshold; or
refraining from transmitting the communication based at least in part on identifying that the measurement satisfies the threshold.
